(19) United States
(12) Patent Application Publication
(10) Pub. No.: US 2016/0012956 A1
(43) Pub. Date: Jan. 14, 2016

(54) THIN-TYPE COMMON MODE FILTER AND MANUFACTURING METHOD THEREOF

(71) Applicant: SAMSUNG ELECTRO-MECHANICS CO., LTD., Suwon-Si (KR)

(72) Inventors: Ju Hwan YANG, Suwon-si (KR); Young Seuck YOO, Seoul (KR); Geon Se JANG, Seoul (KR); Jong Yun LEE, Incheon-si (KR); Young Do KWEON, Suwon-si (KR); Sung Kwon WI, Seoul (KR)

(21) Appl. No.: 14/329,224

(22) Filed: Jul. 11, 2014

(51) Int. Cl. H01F 27/28; H01F 41/32

(52) U.S. Cl. CPC H01F 27/2804; H01F 41/32

(57) ABSTRACT

Disclosed herein are a thin-type common mode filter and a manufacturing method thereof. According to an exemplary embodiment of the present invention, a thin-type common mode filter includes: a ferrite substrate having an upper surface on which irregular surface roughness is formed; an insulating layer formed on the upper surface of the ferrite substrate; and a conductive coil pattern formed in the insulating layer to be spaced apart from the upper surface of the ferrite substrate. Further, a manufacturing method of a thin-type common mode filter is proposed.

### BACKGROUND OF THE INVENTION

1. Technical Field

The present invention relates to a thin-type common mode filter and a manufacturing method thereof. More specifically, the present invention relates to a thin-type common mode filter and a manufacturing method thereof capable of improving an interface adhesion between a ferrite substrate and an insulating layer.

2. Description of the Related Art

Generally, a thin-type common mode filter (CMF) is formed by coating an insulating layer on a substrate and forming a copper coil thereon by a plating method. The weakest portion of the thin-type common mode filter under high temperature/humidity environment is an interface between the substrate and the insulating layer. By making an adhesion of the interface more excellent than the existing adhesion, reliability may be improved.

In the thin-type common mode filter, since a coil pattern serves as an inductor, for example, the copper coil is formed on the substrate by plating, having the insulating layer therebetween. In this case, a pattern shape of the coil may be formed by performing PR patterning and filling a plating material therebetween.

When a load above a certain voltage is applied under the high temperature/humidity environment of the existing thin-type common mode filter, micro cracks are more likely to occur at the interface between the substrate having structural weaknesses and the insulating layer than at other portions.

### RELATED ART DOCUMENT

### Patent Document

(Patent Document 1) Korean Patent Laid-Open Publication No. 10-2011-0014068 (laid-open published on Feb. 10, 2011)

### SUMMARY OF THE INVENTION

An object of the present invention is to increase an interface adhesion between a ferrite substrate and an insulating layer in a thin-type common mode filter.

Another object of the present invention is to keep electrical/mechanical reliability of a thin-type common mode filter under high temperature/humidity environment by improving an interface adhesion between a ferrite substrate and an insulating layer.

According to an exemplary embodiment of the present invention, there is provided a thin-type common mode filter including: a ferrite substrate having an upper surface on which irregular surface roughness is formed; an insulating layer formed on the upper surface of the ferrite substrate; and a conductive coil pattern formed in the insulating layer to be spaced apart from the upper surface of the ferrite substrate.

The surface roughness may be formed so that ten point average roughness Rz ranges from 0.2 μm or more to 1 μm or less.

An average thickness between the conductive coil pattern and the ferrite substrate may range from 2 μm or more to 6 μm or less.

A ratio of an average thickness between the conductive coil pattern and the ferrite substrate to ten point average roughness Rz of the surface roughness may range from 2 to 20.

The ferrite substrate may be a soft magnetic substrate.

The conductive coil pattern may include two spiral line patterns having the same center.

The two spiral line patterns may form a point symmetry with respect to the same center.

According to another exemplary embodiment of the present invention, there is provided a manufacturing method of a thin-type common mode filter including: forming irregular surface roughness on an upper surface of a ferrite substrate; forming a first insulating layer on the upper surface of the ferrite substrate on which the surface roughness is formed; forming a conductive coil pattern on the first insulating layer; and forming a second insulating layer on the conductive coil pattern to form the insulating layer so that the conductive coil pattern is inserted into an insulating layer configured of the first insulating layer and the second insulating layer.

In the forming of the surface roughness, the surface roughness may be formed so that ten point average roughness Rz ranges from 0.2 μm or more to 1 μm or less.

In the forming of the first insulating layer, the first insulating layer may be formed so that an average thickness of the first insulating layer is 5 μm or less.

The surface roughness and the first insulating layer may be formed so that a ratio of an average thickness of the first insulating layer to ten point average roughness Rz of the surface roughness ranges from 2 to 20.

In the forming of the surface roughness, the surface roughness may be formed by plasma dry etching.

The plasma dry etching may be performed using O₂ or CF₄ gas.

In the forming of the conductive coil pattern, the conductive coil pattern may include two spiral line patterns having the same center and the conductive coil pattern may be formed so that the two spiral line patterns form a point symmetry with respect to the same center.

### BRIEF DESCRIPTION OF THE DRAWINGS

FIG. 1 is a cross-sectional view schematically illustrating a thin-type common mode filter according to an exemplary embodiment of the present invention.

FIG. 2 is a diagram schematically illustrating a conductive coil pattern of a thin-type common mode filter according to another exemplary embodiment of the present invention.

FIG. 3 is an enlarged photograph of an interface between a ferrite substrate and an insulating layer of the thin-type common mode filter according to the exemplary embodiment of the present invention.

FIG. 4 is a graph schematically illustrating electrical load characteristics of the thin-type common mode filter according to the exemplary embodiment of the present invention.

FIG. 5 is a flow chart schematically illustrating a manufacturing method of a thin-type common mode filter according to an exemplary embodiment of the present invention.

### DESCRIPTION OF THE PREFERRED EMBODIMENTS

Exemplary embodiments of the present invention for accomplishing the above-mentioned objects will be described with reference to the accompanying drawings. In the description, the same reference numerals will be used to describe the same components of which a detailed description will be omitted in order to allow those skilled in the art to understand the present invention.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

Although a singular form is used in the present description, it may include a plural form as long as it is opposite to the concept of the present invention and is not contradictory in view of interpretation or is used as a clearly different meaning. It should be understood that “include”, “have”, “comprise”, “be configured to include”, and the like, used in the present description do not exclude presence or addition of one or more other characteristic, component, or a combination thereof.

The accompanying drawings referred in the present description may be examples for describing exemplary embodiments of the present invention. In the accompanying drawings, a shape, a size, a thickness, and the like, may be exaggerated in order to effectively describe technical characteristics.

First, a thin-type common mode filter according to an exemplary embodiment of the present invention will be described in detail with reference to the accompanying drawings. In the specification, the same reference numerals will be used in order to describe the same components throughout the accompanying drawings.

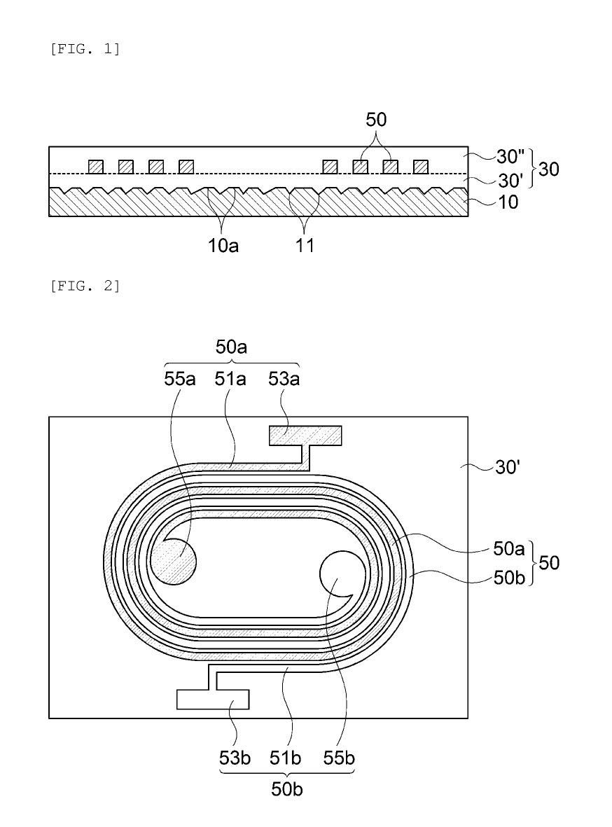

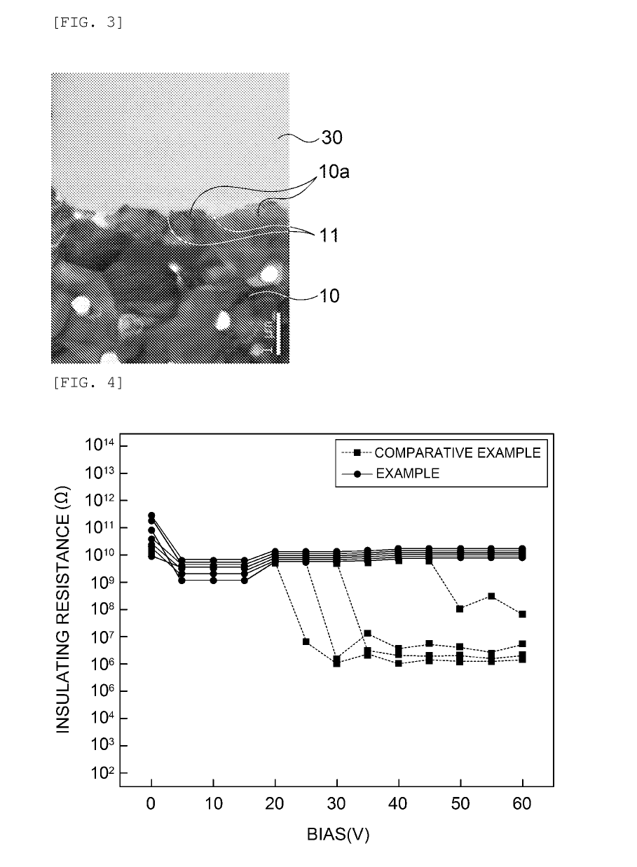

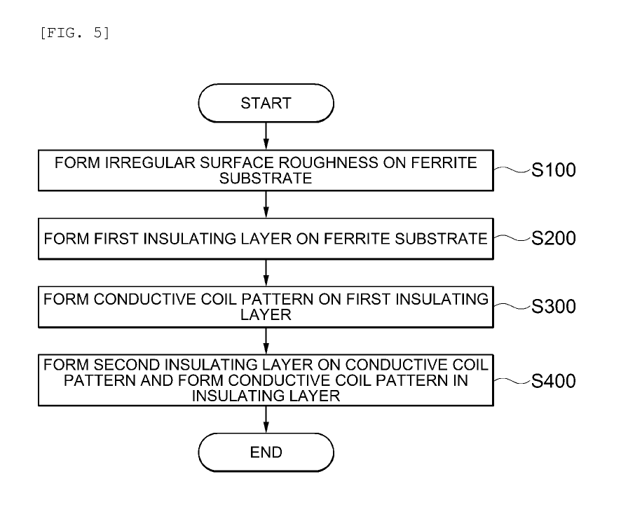

FIG. 1 is a cross-sectional view schematically illustrating a thin-type common mode filter according to an exemplary embodiment of the present invention, FIG. 2 is a diagram schematically illustrating a conductive coil pattern of a thin-type common mode filter according to another exemplary embodiment of the present invention, and FIG. 3 is an enlarged photograph of an interface between a ferrite substrate and an insulating layer of the thin-type common mode filter according to the exemplary embodiment of the present invention. FIG. 4 is a graph schematically illustrating electrical load characteristics of the thin-type common mode filter according to the exemplary embodiment of the present invention.

Referring to FIG. 1, a thin-type common mode filter (CMF) according to the exemplary embodiment of the present invention includes a ferrite substrate 10, an insulating layer 30, and a conductive coil pattern 50.

Referring to FIGS. 1 and 3, the ferrite substrate 10 of the thin-type common mode filter has an upper surface 10a on which irregular surface roughness is formed. The irregular surface roughness on the ferrite substrate 10 is to increase an interface adhesion with the insulating layer 30. For example, the irregular surface roughness on the ferrite substrate 10 may be formed by plasma etching. For example, the surface roughness may be formed on the ferrite substrate 10 by plasma dry etching using O₂ or CF₄ gas. For example, the surface roughness may be formed by colliding F ions with the upper surface 10a of the ferrite substrate to be combined with ferrite particles and fly the F ions. When the F ions are flied while being combined with the ferrite particles of the upper surface 10a, a groove 11 is formed and thus the irregular surface roughness may be generally formed.

For example, the ferrite substrate 10 may be a soft magnetic substrate. Generally, ferrite is a magnetic substance which consists of oxides such as iron, cobalt, nickel, and manganese and is divided into a ferromagnetic substance and a soft magnetic substance according to a magnetic nature. The soft magnetic ferrite substance is referred to as soft ferrite. Unlike the ferromagnetic substance permanently having magnetism, the soft magnetic substance has magnetism only when a current is applied.

For example, referring to FIG. 3, the surface roughness on the ferrite substrate 10 may be formed so that ten point average roughness Rz may range from 0.2 μm or more to 1 μm or less. In this case, the ten point average roughness may be equal to or more than 0.2 μm. For example, since the insulating layer 30 may include filler having a particle size of about 0.1 to 0.2 μm, when the insulating layer intends to serve as an anchor so as to increase the adhesion, the ten point average roughness may require a size of about 0.2 μm or more. Meanwhile, when the ten point average roughness is large and an average thickness between the conductive coil pattern 50 and the ferrite substrate 10 is small, the conductive coil pattern 50 may directly contact the ferrite substrate 10 and therefore the ten point average roughness of the ferrite substrate 10 may be set to be 0.5 times or less than the average thickness between the conductive coil pattern 50 and the ferrite substrate 10. For example, the average thickness between the conductive coil pattern 50 and the ferrite substrate 10 may be set to be equal to or more than 2 μm and the ten point average roughness Rz on the ferrite substrate 10 may be set to be equal to or less than 1 μm.

More preferably, the ten point average roughness Rz on the ferrite substrate 10 may range from 0.5 to 1 μm.

Further, in one example, a ratio of the average thickness between the conductive coil pattern 50 and the ferrite substrate 10 to the ten point average roughness Rz of the surface roughness on the ferrite substrate 10 may range from 2 to 20.

When the surface roughness is formed on the upper surface 10a of the ferrite substrate 10 according to the exemplary embodiment of the present invention, it was confirmed that a plasma etched ferrite substrate has a surface contact angle of purified water (D.I. water) lower than that of the existing no-plasma treatment substrate. This means that an adhesion with a liquid material is increased. Further, it was confirmed that an adhesion is increased even in an adhesion evaluation on the ferrite substrate 10 of the insulating layer 30 based on a shear test for the insulating layer 30 bonded on the ferrite substrate 10 on which the surface roughness is formed.

As illustrated in FIG. 4, it may be appreciated that the increased adhesion improves the electrical load characteristics under the high temperature and humidity environment of a product.

FIG. 4 illustrates comparison results of the electrical load characteristics by performing a ‘85/85 test’ which confirms operation performance of a device by permeating moisture particles into a device interface and measuring a resistance value while applying a bias voltage, under the high temperature/humidity environment, for example, chamber environment having humidity of 85% and temperature of 85° C. of the thin-type common mode filter (CMF) having the plasma etched ferrite substrate 10 according to an example of the present invention and the thin-type common mode filter (CMF) of comparative example having the normal ferrite substrate 10 which is not plasma-treated. In FIG. 4, describing an insulating resistance at the bias voltage which is over 20 v, for example, the bias voltage of 25 V. it may be appreciated that the electrical load characteristics of the thin-type common mode filter (CMF) product according to the comparative example of the related art are remarkably reduced, while the thin-type common mode filter (CMF) product according to the example of the present invention has a constant insulating resistance.

Next, the insulating layer 30 of the thin-type common mode filter will be described with reference to FIGS. 1 and 3. The insulating layer 30 is formed on the upper surface 10a of the ferrite substrate 10. In this case, the insulating layer 30 is to electrically insulate the conductive coil pattern 50 inserted thereinto from an outside of the insulating layer 30. When the insulating layer 30 has the increased interface adhesion with the ferrite substrate 10, the insulating layer 30 may have the excellent electrical load characteristics under the high temperature/humidity environment, and the like. Therefore, according to the exemplary embodiment of the present invention, the insulating layer 30 is formed on the upper surface 10a of the ferrite substrate 10 on which the surface roughness is formed to increase the interface adhesion.

As a material of the insulating layer 30 formed on the ferrite substrate 10, a known insulating material in a field of the thin-type common mode filter may be used. For example, a liquid insulating material is coated and dried on the ferrite substrate 10 on which the surface roughness is formed to form the insulating layer 30, for example, a first insulating layer 30′ of FIG. 5. Alternatively, the insulating layer 30 or the first insulating layer 30′ may also be formed by stacking an insulating sheet of a dry film material. For example, the insulating layer 30 may be mainly coated in a liquid form. In this case, the insulating layer is coated and then dried and hardened and thus the adhesion with the upper surface 10a of the ferrite substrate 10 may be secured. In particular, a specific surface area is widened by forming the roughness on the upper surface 10a of the ferrite substrate 10 and thus a contact area is widened, such that the interface adhesion may be increased.

For example, referring to FIG. 5, the insulating layer 30 may be formed by forming the first insulating layer 30′ on, for example, the ferrite substrate 10, forming the conductive coil pattern 50, and then forming a second insulating layer 30″. Referring to FIG. 1, the insulating layer 30 may be configured of the first insulating layer 30′ interposed between the conductive coil pattern 50 and the ferrite substrate 10 and the second insulating layer 30″ covering the conductive coil pattern 50 formed on the first insulating layer 30′.

In this case, the first insulating layer 30′ and the second insulating layer 30″ may be made of the same insulating material. Alternatively, the first and second insulating layers 30′ and 30″ are made of hetero insulating material having an excellent adhesion therebetween.

In one example, the average thickness between the conductive coil pattern 50 and the ferrite substrate 10, for example, the average thickness of the first insulating layer 30′ may range from 2 μm or more to 6 μm or less.

For example, a ratio of the average thickness between the conductive coil pattern 50 and the ferrite substrate 10, for example, the average thickness of the first insulating layer 30′ to the ten point average roughness Rz of the surface roughness formed on the ferrite substrate 10 may range from 2 to 20.

Next, the conductive coil pattern 50 of the thin-type common mode filter will be described in detail with reference to FIGS. 1 and 2. In this case, the conductive coil pattern 50 is formed to be spaced apart from the upper surface 10a of the ferrite substrate 10 within the insulating layer 30. For example, the conductive coil pattern 50 may be formed by plating a conductive metal. For example, the conductive coil pattern 50 may be formed by plating Cu. For example, a section of a pattern line may have a rectangular structure using a pattern mask at the time of plating. For example, the structure of the conductive coil pattern 50 may be formed by a plating method so that a thickness and a width of each pattern line and an interval between the pattern lines are set to be about 10 μm or less.

Describing one example with reference to FIG. 2, the conductive coil pattern 50 may include two spiral line patterns 50a and 50b having the same center. For example, the first conductive coil pattern 50a and the second conductive coil pattern 50b may have a spiral structure having the same center at a constant interval. In this case, the spiral structure may have various structures such as a circular shape, a squared shape, and an oval shape.

For example, the first and second conductive coil patterns 50a and 50b may each include spiral lines 51a and 51b, inside draw out terminals 55a and 55b, and outside draw out terminals 53a and 53b. The inside draw out terminals 55a and 55b have a spiral shape formed therein and are a draw out terminal which is connected to an external electrode (not illustrated) and the outside draw out terminals 53a and 53b are a draw out terminal which is directly connected to the external electrode (not illustrated).

In one example, the two spiral line patterns 50a and 50b may form a point symmetry with respect to the same center. FIG. 2 illustrates a structure in which the two spiral structures having an oval shape form a point symmetry with respect to the same center. In this case, the inside draw out terminals 55a and 55b and the outside draw out terminals 53a and 53b may each form a point symmetry.

Next, a manufacturing method of a thin-type common mode filter according to another exemplary embodiment of the present invention will be described with reference to the accompanying drawings. In this case, the thin-type common mode filters according to the foregoing exemplary embodiment of the present invention and FIGS. 1 to 4 will be referred and an overlapping description will be omitted.

FIG. 5 is a flow chart schematically illustrating a manufacturing method of a thin-type common mode filter according to an exemplary embodiment of the present invention.

Describing the manufacturing method of a thin-type common mode filter according to the exemplary embodiment of the present invention with reference to FIG. 5, the manufacturing method of a thin-type common mode filter includes forming the surface roughness (S100), forming the first insulating layer 30′ (S200), forming the conductive coil pattern (S300), and forming the second insulating layer 30″ (S400).

Referring to FIG. 5, in the forming of the surface roughness (S100), the irregular surface roughness is formed on the upper surface 10a of the ferrite substrate 10. The irregular surface roughness on the surface or upper surface 10a of the ferrite substrate is to increase the adhesion with the first insulating layer 30′.

In one example, in the forming of the surface roughness (S100), the surface roughness may be formed so that the ten point average roughness Rz ranges from 0.2 μm or more to 1 μm or less.

Further, in one example, the surface roughness may be formed so that a ratio of the average thickness of the first insulating layer 30′ to the ten point average roughness Rz of the surface roughness ranges from 2 to 20.

Further, according to one example, in the forming of the surface roughness (S100), the surface roughness may be formed on the upper surface 10a of the ferrite substrate by the plasma dry etching. In one example, the plasma dry etching may be performed using gas of O₂, CF₄, or the like. The plasma dry etching is performed on the upper surface 10a of the ferrite substrate using O₂ or CF₄ gas to combine plasma ions with the particles of the upper surface 10a of the ferrite substrate and separate the plasma ions from the upper surface 10a of the substrate so as to form the grooves 11 on the upper surface 10a of the ferrite substrate, thereby forming the surface roughness. In this case, the grooves 11 formed by the plasma dry etching are distributed in an irregularly cut shape and therefore the irregular surface roughness may be formed.

A principle of forming the surface roughness on the surface or upper surface 10a of the ferrite substrate 10 will be described by way of example. For example, in the case of the plasma dry etching using the CF₄ gas, when the CF₄ gas is ionized to collide the F ions with the upper surface 10a of the ferrite substrate, the F ions are combined with the ferrite particles and the combined FerriteFx is separated from the upper surface 10a and the grooves 11 are irregularly formed on the upper surface 10a of the ferrite substrate, such that the surface roughness may be formed on the ferrite substrate 10. A reaction formula of the upper surface 10a of the ferrite substrate and the F ions is as follows.

Ferrite(Fe, Ni, Cu, Zn, O)+F->FerriteFx

According to the exemplary embodiment of the present invention, when the surface roughness is formed on the upper surface 10a of the ferrite substrate 10, it was confirmed that the plasma etched ferrite substrate has a surface contact angle of a liquid material lower than that of the existing no-plasma treatment substrate, such that the adhesion between the upper surface 10a of the ferrite surface and the liquid material may be increased.

As illustrated in FIG. 4, it may be appreciated that the increased adhesion improves the electrical load characteristics under the high temperature and humidity environment of a product. In FIG. 4, describing the insulating resistance when the bias voltage is over a certain range, it may be appreciated that the insulating resistance of the thin-type common mode filter (CMF) product according to the comparative example of the related art is suddenly reduced, while the thin-type common mode filter (CMF) product according to the example of the present invention has a constant insulating resistance.

Next, referring to FIG. 5, in the forming of the first insulating layer 30′ (S200), the first insulating layer 30′ is formed on the upper surface 10a of the ferrite substrate 10 on which the surface roughness is formed. For example, the first insulating layer 30′ may be formed by coating, drying, and hardening the liquid material. The material of the first insulating layer 30′ is not limited to the liquid material.

For example, in the forming of the first insulating layer 30′ (S200), the first insulating layer 30′ may be formed so that the average thickness of the first insulating layer 30′ is equal to or less than 5 μm.

Further, in one example, the first insulating layer 30′ may be formed so that a ratio of the average thickness of the first insulating layer 30′ to the ten point average roughness Rz of the surface roughness ranges from 2 to 20.

Referring continuously to FIG. 5, in the forming of the conductive coil pattern (S300), the conductive coil pattern 50 is formed on the first insulating layer 30′. The conductive coil pattern 50 may be formed on the first insulating layer 30′ by, for example, the plating method and the exemplary embodiment of the present invention is not limited thereto. For example, the conductive coil pattern 50 may be formed by plating the conductive metal. For example, the conductive coil pattern 50 may be formed by performing the PR patterning and filling a plating material such as Cu therebetween. For example, the conductive metal may be plated on a plating seed layer of 1 μm or less by electroplating.

Further, according to one example with reference to FIG. 2, in the forming of the conductive coil pattern 50 (S300), the conductive coil pattern 50 may include the two spiral line patterns having the same center. For example, the conductive coil pattern 50 may be formed so that the two spiral line patterns form a point symmetry with respect to the same center.

Next, referring to FIG. 5, in the forming of the second insulating layer 30″ (S400), the second insulating layer 30″ is formed on the conductive coil pattern 50. The second insulating layer 30″ is to cover the conductive coil pattern 50 and is formed to vertically enclose the conductive coil pattern 50 along with the first insulating layer 30′. The insulating material of the second insulating layer 30″ may use the same material as the material of the first insulating layer 30′ or hetero insulating materials having excellent bonding may also be used. For example, similar to the first insulating layer 30′, the liquid insulating material is applied on the conductive coil pattern 50 formed on the first insulating layer 30′ and then dried and hardened to form the second insulating layer 30″. Alternatively, the second insulating layer 30″ of the film material is stacked on the conductive coil pattern 50 formed on the first insulating layer 30′ and then compressed to form the second insulating layer 30″.

In this case, in the forming of the second insulating layer 30″ (S400), the second insulating layer 30″ is formed to insert the conductive coil pattern 50 into the insulating layer 30 configured of the first and second insulating layers 30″ and thus the insulating layer 30 covering the conductive coil pattern 50 formed therein may be formed.

According to the exemplary embodiments of the present invention, it is possible to increase the interface adhesion between the ferrite substrate and the insulating layer in the thin-type common mode filter.

Accordingly, it is possible to keep the electrical/mechanical reliability of the thin-type common mode filter under the high temperature/humidity environment. That is, according to the exemplary embodiments of the present invention, it is possible to improve the electrical load characteristics of the thin-type common mode filter under the high temperature/humidity environment by increasing the adhesion at the interface between the ferrite substrate and the insulating layer.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. A thin-type common mode filter, comprising:
a ferrite substrate having an upper surface on which irregular surface roughness is formed;
an insulating layer formed on the upper surface of the ferrite substrate; and
a conductive coil pattern formed in the insulating layer to be spaced apart from the upper surface of the ferrite substrate.

2. The thin-type common mode filter according to claim 1, wherein the surface roughness is formed so that ten point average roughness Rz ranges from 0.2 μm or more to 1 μm or less.

3. The thin-type common mode filter according to claim 1, wherein an average thickness between the conductive coil pattern and the ferrite substrate ranges from 2 μm or more to 6 μm or less.

4. The thin-type common mode filter according to claim 1, wherein a ratio of an average thickness between the conductive coil pattern and the ferrite substrate to ten point average roughness Rz of the surface roughness ranges from 2 to 20.

5. The thin-type common mode filter according to claim 1, wherein the ferrite substrate is a soft magnetic substrate.

6. The thin-type common mode filter according to claim 2, wherein the ferrite substrate is a soft magnetic substrate.

7. The thin-type common mode filter according to claim 4, wherein the ferrite substrate is a soft magnetic substrate.

8. The thin-type common mode filter according to claim 1, wherein the conductive coil pattern includes two spiral line patterns having the same center.

9. The thin-type common mode filter according to claim 2, wherein the conductive coil pattern includes two spiral line patterns having the same center.

10. The thin-type common mode filter according to claim 4, wherein the conductive coil pattern includes two spiral line patterns having the same center.

11. The thin-type common mode filter according to claim 8, wherein the two spiral line patterns form a point symmetry with respect to the same center.

12. A manufacturing method of a thin-type common mode filter, comprising:
forming irregular surface roughness on an upper surface of a ferrite substrate;
forming a first insulating layer on the upper surface of the ferrite substrate on which the surface roughness is formed;
forming a conductive coil pattern on the first insulating layer; and
forming a second insulating layer on the conductive coil pattern to form the insulating layer so that the conductive coil pattern is inserted into an insulating layer configured of the first insulating layer and the second insulating layer.

13. The manufacturing method according to claim 12, wherein in the forming of the surface roughness, the surface roughness is formed so that ten point average roughness Rz ranges from 0.2 μm or more to 1 μm or less.

14. The manufacturing method according to claim 12, wherein in the forming of the first insulating layer, the first insulating layer is formed so that an average thickness of the first insulating layer is 5 μm or less.

15. The manufacturing method according to claim 12, wherein the surface roughness and the first insulating layer are formed so that a ratio of an average thickness of the first insulating layer to ten point average roughness Rz of the surface roughness ranges from 2 to 20.

16. The manufacturing method according to claim 12, wherein in the forming of the surface roughness, the surface roughness is formed by plasma dry etching.

17. The manufacturing method according to claim 15, wherein in the forming of the surface roughness, the surface roughness is formed by plasma dry etching.

18. The manufacturing method according to claim 16, wherein the plasma dry etching is performed using O₂ or CF₄ gas.

19. The manufacturing method according to claim 12, wherein in the forming of the conductive coil pattern, the conductive coil pattern includes two spiral line patterns having the same center and the conductive coil pattern is formed so that the two spiral line patterns form a point symmetry with respect to the same center.

20. The manufacturing method according to claim 15, wherein in the forming of the conductive coil pattern, the conductive coil pattern includes two spiral line patterns having the same center and the conductive coil pattern is formed so that the two spiral line patterns form a point symmetry with respect to the same center.
